(19) United States
(12) Patent Application Publication
(10) Pub. No.: US 2026/0030771 A1
(43) Pub. Date: Jan. 29, 2026

(54) METHODS FOR LANDMARK-FREE THREE-DIMENSIONAL POINT CLOUD MODELING AND ANALYSIS

(71) Applicant: Purdue Research Foundation, West Lafayette, IN (US)

(72) Inventor: Erik R. Otárola-Castillo, West Lafayette, IN (US)

(73) Assignee: Purdue Research Foundation, West Lafayette, IN (US)

(21) Appl. No.: 19/281,639

(22) Filed: Jul. 26, 2025

Related U.S. Application Data
(60) Provisional application No. 63/675,906, filed on Jul. 26, 2024.

(51) Int. Cl. G06T 7/60; G06T 3/40; G06T 3/60; G06T 15/00; G06V 10/24

(52) U.S. Cl. CPC G06T 7/60; G06T 3/40; G06T 3/60; G06T 15/00; G06V 10/24; G06T 2207/20081; G06T 2207/20084; G06V 2201/07

(57) ABSTRACT

A tool mark identification method for analyzing bone surface modifications includes receiving a plurality of known images with known attributes, receiving a plurality of unidentified images with unknown attributes including aberrations, aligning the received plurality of known images to thereby generate a plurality of aligned known images, aligning the received plurality of unidentified images to thereby generate a plurality of aligned unidentified images, training a model using the plurality of aligned known images to thereby form a trained model, and applying the plurality of aligned unidentified images to the trained model, thereby predicting tool marks that generated the aberrations in the unknown attributes.

### CROSS-REFERENCE TO RELATED APPLICATIONS

The present non-provisional patent application is related to and claims the priority benefit of U.S. Provisional Patent Application Ser. 63/675,906, filed Jul. 26, 2024, the contents of which are hereby incorporated by reference in its entirety into the present disclosure.

### STATEMENT REGARDING GOVERNMENT FUNDING

None.

### TECHNICAL FIELD

The present disclosure generally relates to methods associated with bone surface modifications and in particular to methods associated with bone surface modifications for landmark-free three-dimensional point cloud modeling and analysis.

### BACKGROUND

This section introduces aspects that may help facilitate a better understanding of the disclosure Accordingly, these statements are to be read in this light and are not to be understood as admissions about what is or is not prior art.

The study of bone surface modifications (BSMs) is critical in many fields, including archaeology and forensic science. For example, BSM analysis is used to reconstruct past human dietary behaviors. BSMs, such as cut marks, chop marks, percussion marks, and tooth marks, provide direct evidence of human-animal interactions including hunting, scavenging, and processing activities. Archaeologists rely on these traces to infer tool use, subsistence strategies, and even socioeconomic or gendered divisions of labor. This analysis plays a central role in understanding the role of meat consumption and carcass processing in the evolution of early human societies.

In forensic science, BSM analysis also plays a critical role in modern death investigations where sharp force trauma is involved. Sharp force trauma includes injuries caused by knives or other sharp objects and is the third most common type of trauma seen by medical examiners in the United States. In the United Kingdom, it's now considered the leading cause of murder, with knife-related attacks increasing by 9% in the past year. These patterns highlight the importance of studying sharp force trauma in forensic science, especially to better understand how it affects the human skeleton.

Sharp force injuries, comprising stab wounds, incised wounds, and chop wounds, are particularly relevant as they often leave distinctive traces on bone and soft tissue. Such injuries occur when sharp or pointed instruments, like knives, machetes, or axes, contact the body, producing relatively well-defined separations of tissue. These wounds differ in terms of force direction and depth. Stab wounds are typically deeper than wide. Incised wounds are longer than deep. Chop wounds combine blunt and sharp characteristics. Careful examination of wound morphology, including number, location, dimensions, and associated damage to clothing or bone, can help identify the type of weapon used and distinguish between homicidal, suicidal, and accidental injuries.

While it is less common than gunshot trauma, sharp force injuries account for a significant proportion of violent deaths. In the United States, they were responsible for 8.1 percent of all homicides and 2.1 percent of suicides in 2021. Epidemiological studies show that in regions with stricter firearm regulations, sharp force trauma becomes a more frequent means of homicide, as seen in Oslo (27 percent), Lisbon (31 percent), and Stockholm (37 percent). These trends reinforce the relevance of BSM analysis in both medico-legal and archaeological contexts. When skeletal remains are recovered, detailed examination of cut marks and fracture patterns can not only help reconstruct past behavior and violence but also identify or rule out specific weapons found at a scene, bridging disciplines such as forensic pathology and computational anthropology.

Although BSMs may be visually identified and distinguished, quantifying them to measure their variability offers several advantages over describing the visual differences, especially in forensic applications where visual inspections are simply not sufficient. Using the language of mathematics, quantitative measurement enables precise and accurate descriptions, promoting clear and effective communication among scientists and allowing objective comparisons across different archaeological contexts. Mathematical language also facilitates BSM descriptions based on the principles of physics, biomechanics, and the forces involved in their formation, offering more fundamental insights into the variability in human butchery behavior and the selection pressures underlying the human evolutionary trajectory. By quantifying BSMs, researchers can more precisely measure their morphological variability, thereby accurately estimating the population parameters of BSMs made by different agents such as human tools, animal trampling and gnawing, and other taphonomic processes.

This detailed level of quantification for measurement is vital for testing hypotheses related to human subsistence strategies, such as the extent and methods of hunting and butchering practices and subsistence transitions, or for forensic application, e.g., to identify the type of weapon used in a homicide investigation. Moreover, standardized quantification enables study replication, providing a robust framework for validating findings and ensuring consistent interpretation. In addition, comparative analysis of quantified BSMs can reveal patterns and trends in human-animal interactions, for example, clarifying the controversial role of humans in the extinction of megafauna and other significant ecological shifts. Ultimately, rigorous measurement and comparison of BSMs enhance our capacity to construct scientific theoretical models that generate empirical predictions, allowing data-driven reconstructions of past human behaviors.

One way to quantify BSM is to digitize the marks using a 3D scanner and then analyze the resulting model using landmark-based 3D geometric morphometrics (GM), as conducted in biological sciences and archaeology. While other methods exist, GM methods are optimal shape estimators that are considered unbiased and can detect subtle signals with smaller sample sizes (i.e., more statistically powerful), by standardizing shape variation while removing non-shape variation through Generalized Procrustes Analysis. Others have developed robust approaches for studying BSMs using advanced 3D GM and Bayesian statistical methods. For example, in 2018 one group used 3D GM to discern among cut marks made to simulate different butchery behaviors, a process critical to understanding variations in butchery techniques. They began by creating 3D models of experimentally generated cut marks using confocal microscopy and cleaning the scans with MeshLab software. The researchers employed landmark- and sliding semi-landmark-based GM to analyze these marks' entire 3D surface morphology, allowing for a comprehensive statistical analysis identifying subtle differences between types of cut marks.

In their 2023 study, this method was refined by combining 3D imaging and Bayesian statistics to analyze BSM on the Bowser Road Mastodon. They created 3D models of experimental chop marks and the BSM found on the mastodon bones. By applying similar methods, including GM and statistical analyses, they compared the shapes of these marks to assess their likelihood of being produced by specific butchery actions. These and similar approaches provide a measurable, more objective, and replicable framework than visual inspection alone for interpreting BSMs, enhancing the ability to make precise and reliable inferences about human-animal (megafauna) interactions in the archaeological record.

Because Type 1 and Type 2 homologous landmarks were difficult to find on BSM, these studies utilized the sliding semi-landmark method, commonly used for surfaces with few definitive landmarks. These studies employed two homologous landmarks, marking the beginning and end of the marks. However, even this limited number of homologous landmarks on BSM are difficult or impossible to identify, especially on non-experimental sub-fossil and fossil bones. This is not a problem unique to BSM analyses and is shared across multiple fields using 3D surface data. Sometimes, a definitive morphological characteristic of the beginning and end of a mark may be unrecognizable and impossible to locate accurately, and the very ends of the point clouds may just be assumed to be these landmarks rather than empirically verified.

However, identifying characteristics of a tool mark and analyzing BSMs accordingly requires significant human time and input and still needs improvements for objectively quantifying the BSM due to effect of a tool, e.g., a knife.

Thus, there is an unmet need for a novel approach for quantifying and analyzing BSMs to not only improve the accuracy of identifying marks, but also to gain a fundamental comprehension of the range of BSM variability for archaeological and medico-legal forensic applications.

### SUMMARY

A system for identifying tool marks when analyzing bone surface modifications is disclosed. The system includes an image capture device adapted to capture a red-green-blue image from a scene, wherein the image capture device includes a sensor that captures images upon receiving a digital capture input. The system further includes a processor executing software maintained on a non-transitory memory. The processor is configured to receive a plurality of known images with known attributes, receive a plurality of unidentified images with unknown attributes including aberrations, align the received plurality of known images to thereby generate a plurality of aligned known images, align the received plurality of unidentified images to thereby generate a plurality of aligned unidentified images, train a model using the aligned known images to thereby form a trained model, and apply the aligned unidentified images to the trained model, thereby predicting tool marks that generated the aberrations in the unknown attributes.

A tool mark identification method for analyzing bone surface modifications is disclosed. The method includes receiving a plurality of known images with known attributes, receiving a plurality of unidentified images with unknown attributes including aberrations, aligning the received plurality of known images to thereby generate a plurality of aligned known images, aligning the received plurality of unidentified images to thereby generate a plurality of aligned unidentified images, training a model using the plurality of aligned known images to thereby form a trained model, and applying the plurality of aligned unidentified images to the trained model, thereby predicting tool marks that generated the aberrations in the unknown attributes.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1 is a block diagram of a basic flow according to the present disclosure.

FIG. 2 is a block diagram of image alignment, according to the present disclosure.

FIG. 3 provides 3D visualizations of simulated V-shapes and U-shapes based on a transformation parameter, τ (shown as T).

FIG. 4 provides 2D Principal Component Analysis (PCA) plots of point clouds for increasing difference between shapes based on τ (shown as T).

FIG. 5 provides visualization of the p-values across different sample sizes and transformation parameter, τ (shown as T).

FIG. 6 provides visualization of the Z-scores quantifying the number of standard deviations by which the observed difference between groups deviates from a mean difference of zero, effectively serving as an indicator of effect size, across different sample sizes and transformation values of τ (shown as T).

FIG. 7A is a photographs of bone samples providing various trauma marks on bone surfaces.

FIG. 7B is a photograph showing the casting operation.

FIG. 7C is a photograph of scanning operation.

FIG. 8A is an image of 3D scans of molding compounds, which capture fine topographic detail from bone surfaces.

FIG. 8B is an image that shows how scans are then used to segment and extract the relevant region containing the surface modification.

FIG. 8C and FIG. 8D provide images indicating cleaning and refinement of the point cloud data to remove artifacts and noise, and down-sample the specimen to a manageable number of points representing the 3D digital bone surface modification.

FIG. 9 is a point cloud plot which shows sample of BSM following Generalized Procrustes Analysis (GPA), which aligns shapes by removing differences in position, orientation, and size.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

A novel approach is described herein for quantifying and analyzing bone surface modifications (BSMs) to not only improve the accuracy of identifying marks, but also to gain a fundamental comprehension of the range of BSM variability. Towards this end, the present disclosure introduces Generalized Iterative closest Point Procrustes Analysis (GIPPA), a novel geometric morphometrics (GM) “landmark-free” method for quantifying, measuring, and comparing BSMs' morphology. By employing an Iterative Closest Point (ICP) algorithm and KD-tree to register three-dimensional (3D) point clouds as closely as possible and then perform superimposition within the context of GPA, GIPPA calculates the Procrustes distance shape difference metric without relying on corresponding homologous landmarks, a novel approach, unlike methodology in the prior art. Procrustes Analysis is a form of statistical shape analysis used to analyze the distribution of shapes to ascertain various information, such as size, distance, orientation, etc. of the shapes. This approach integrates GM's Generalized Procrustes Analysis (GPA) and computer vision's ICP algorithm and K-dimensional trees (“k-d trees”) to perform landmark-free shape analysis using high-resolution surface scans. By employing the ICP algorithm and KD-tree to register 3D point clouds as closely as possible and then perform superimposition within the context of GPA, GIPPA calculates the Procrustes distance shape difference metric without relying on corresponding homologous landmarks, a novel approach, describing an improvement in methodology of the prior art which represented a technical solution to bone surface modification and took mark identification. This method allows the analysis of complete 3D surface point clouds, offering a comprehensive way to quantify and measure BSM morphology. GIPPA's use of the entire surface for superimposition provides detailed and accurate measurements of morphological variation, making it particularly suited for morphometric analysis of smooth or featureless surfaces where homologous landmark methods may not be applicable. This method, along with subsequent validation and benchmarking simulations discussed below, ensures that the quantification process captures the full complexity of the marks, thereby providing a robust framework for analyzing BSMs in archaeological research.

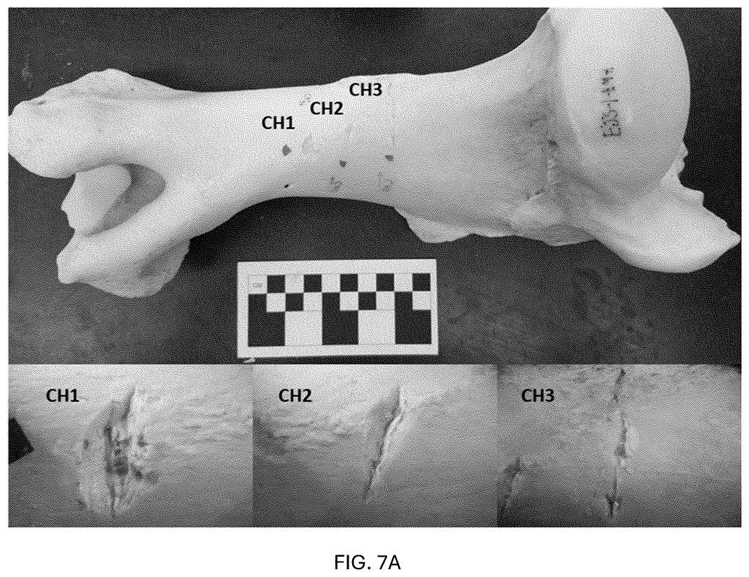

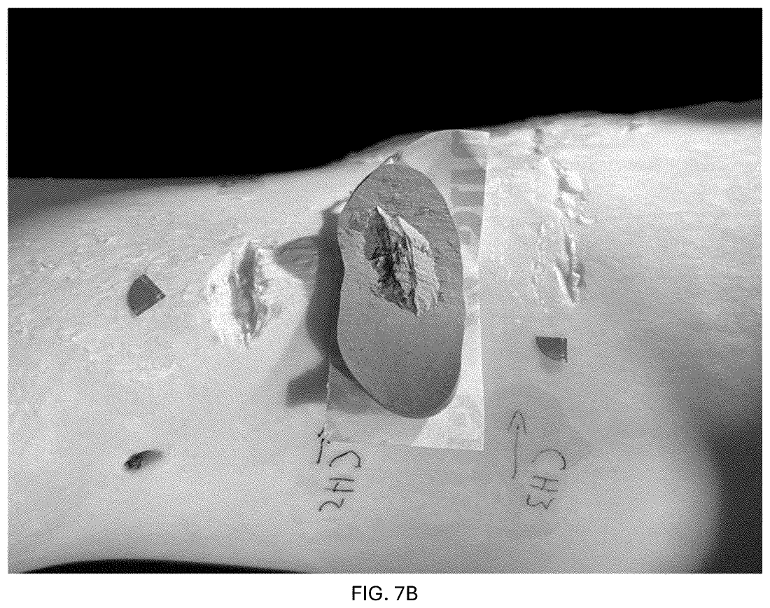

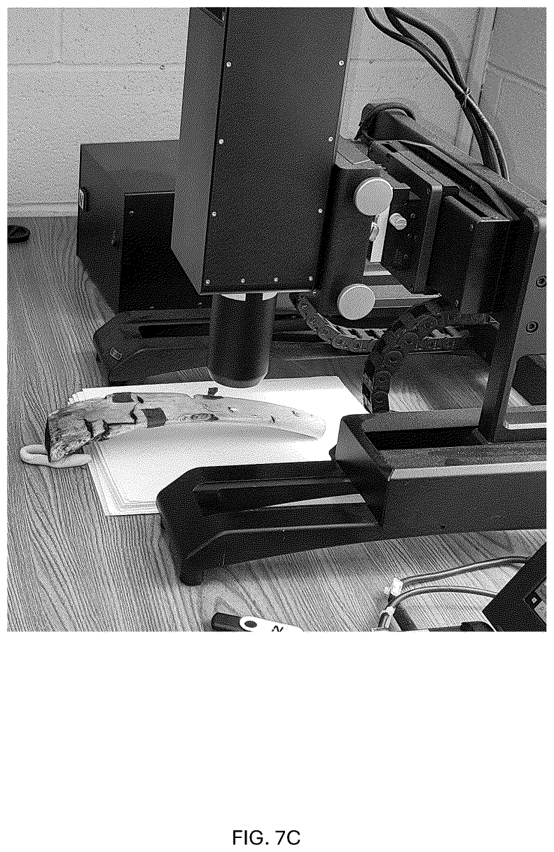

When tackling this problem, we first examine sharp force trauma marks on bone, using BSM. For example, referring to FIG. 7A, photographs of bone samples are shown providing various trauma marks on bone surfaces.

The present method then begins by recording bone surface modifications (BSMs) from bone samples, which are unknown and require identification, as well as from those that are known and created in controlled cutting, stabbing, chopping, and biting experiments. The recording is conducted by creating casts of each mark using a non-destructive micron-level replication method.

This process involves applying a flexible, high-resolution casting compound directly onto the bone surface to capture the fine-scale topography of the modifications, as shown in FIG. 7B, which is a photograph showing the casting operation. Once set, the compound can be removed as what is called “a peel”, producing a detailed negative cast of the BSM without harming the underlying bone. These casts serve as accurate three-dimensional representations of the surface modifications, suitable for generating digital 3D models.

The casts are then scanned using high-resolution surface metrology tools that can capture microscale details, enabling a comparative analysis of BSM features across samples, as shown in FIG. 7C which is a photograph of scanning operation.

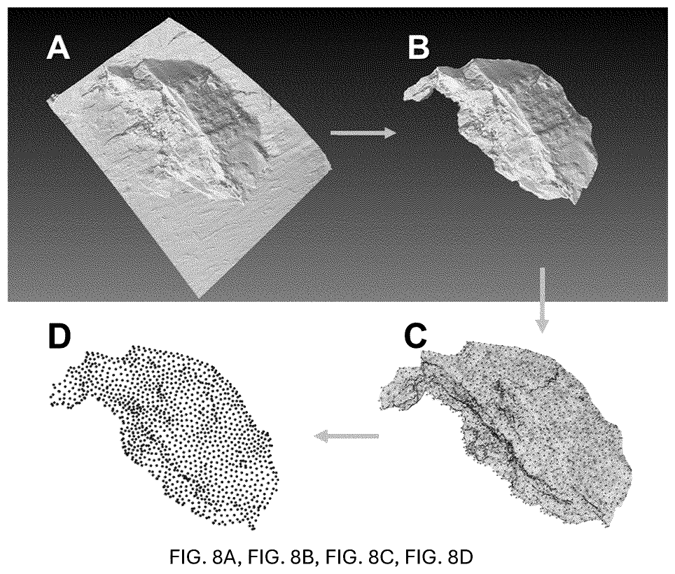

To compare the morphology of BSM, this method follows a multi-step digital workflow for generating, processing, and isolating high-resolution 3D representations of surface modifications, as shown in FIG. 8A, FIG. 8B, FIG. 8C, and FIG. 8D, further described below.

The workflow begins with 3D scans of molding compounds, which capture fine topographic detail from bone surfaces (as provided in FIG. 8A). These scans are then used to segment and extract the relevant region containing the surface modification (as provided in FIG. 8B), followed by cleaning and refinement of the point cloud data to remove artifacts and noise, and down-sample the specimen to a manageable number of points representing the 3D digital BSM (as provided in FIGS. 8C and 8D).

This generalizable approach reflects established practices in digital morphology and surface metrology and can be applied across archaeological and forensic contexts to systematically study surface modifications using traditional morphometrics and landmark- and point-cloud-based 3D geometric morphometrics.

“Traditional” morphometrics involves calculating distances, ratios, and angles between landmarks. These measurements are then often subjected to multivariate statistical analysis. Landmark-based GM enhances this approach by maintaining the spatial relationships between landmarks, preserving the geometric information inherent in their positions. Moreover, statistical benchmarking studies have demonstrated that GM offers superior inferential properties compared to comparable morphometric techniques.

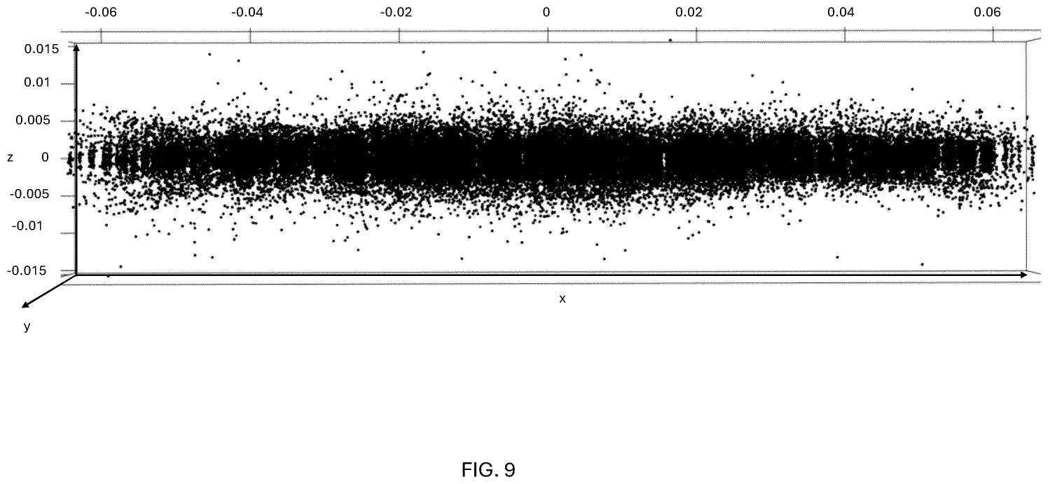

The cornerstone method in GM is GPA, which optimally aligns a set of landmark configurations (point clouds) by eliminating non-shape variations such as location, scale, and orientation differences. This superimposition process results in specimens that differ solely in shape, while the size variable is temporarily “sequestered” for later use. Referring to FIG. 9, a point cloud plot is provided which shows sample of BSM following Generalized Procrustes Analysis (GPA), which aligns shapes by removing differences in position, orientation, and size.

Within this framework, researchers may explore shape patterns within and between populations and investigate the relationship between shape and other variables, such as size, facilitating more nuanced analyses of these morphometric data to evaluate morphological hypotheses. GPA is thus beneficial in biological and archaeological research, enabling researchers to systematically compare morphological features and infer evolutionary or behavioral signals.

The GPA algorithm involves several steps to align and compare shapes using Procrustes distance, typically based on homologous landmarks. The procedure can be described as follows:

First, the input data structure consists of a set of matrices, A[k, p, n], where k represents the number of landmarks, p the dimensions (e.g., 3 for 3D coordinates), and n the number of specimens. Each specimen's landmarks are translated to a common origin by mean-centering all specimens. This translation ensures that the centroid (mean of x, y, z coordinates) of each landmark configuration is at the origin, denoted as:

$${A}_{i}^{′} = {A}_{i} - {\overline{A}}_{ι}$$

where Aᵢ is the centroid of the i-th specimen. Next, the centroid size (cs) of each specimen is computed, defined as the square root of the sum of squared coordinates:

$${cs}_{i} = \sqrt{{\sum }_{j = 1}^{k} ( {x}_{ij}^{2} + {y}_{ij}^{2} + {z}_{ij}^{2}}$$

Each centered specimen is then scaled relative to its centroid size:

$${A}_{i}^{″} = \frac{{A}_{i}^{′}}{{cs}_{i}}$$

The first specimen,

$${A}_{1}^{″} ,$$

is used as the initial reference snape, R:

$$R = {A}_{1}^{″}$$

The iterative alignment process involves scaling the i-th specimen relative to the reference:

$${A}_{i}^{′′′} = \frac{{A}_{i}^{″}}{{cs}_{R}} .$$

To optimally rotate the i-th specimen

$$( {A}_{i}^{′′′} )$$

to the reference shape, R, one minimizes the distances between corresponding landmarks. This involves finding the optimal rotation matrix ROT that aligns

$${A}_{i}^{′′′}$$

to R. The procedure is as follows.

First, a cross-covariance matrix is calculated. The cross-covariance matrix H is calculated between the centered, scaled landmarks of the specimen and the reference shape:

$$H = {A}_{i}^{′′′ T} R$$

Next, singular value decomposition (SVD) is performed. Apply SVD to the cross-covariance matrix H:

$$H = F \sum {G}^{T}$$

Where F and G are orthogonal matrices, and Σ is a diagonal matrix containing the singular values.

Next the optimum rotation matrix is computed. The optimal rotation matrix ROT is obtained by:

$$ROT = {GF}^{T}$$

If the determinant of ROT is negative, indicating a reflection rather than a rotation, the last column of G is negated to ensure a proper rotation (if reflection is undesirable for analysis). That is:

$$if det ( ROT ) < 0 then G [ : , - 1 ] ← - G [ : , - 1 ]$$

Next, the rotation matrix is recomputed:

$$ROT = {GF}^{T}$$

Next, the rotation matrix is applied. Apply the rotation matrix ROT to the centered and scaled coordinates

$${A}_{i}^{′′′}$$

to obtain the new coordinates

$${A}_{i}^{opt} :$$

$${A}_{i}^{opt} = {A}_{i}^{′′′} ROT$$

Next, the reference shape is updated. A new reference shape R_{new} is computed by averaging the points across all specimens:

$${R}_{new} = \frac{1}{n} {\sum }_{i = 1}^{n} {A}_{i}^{opt}$$

Next, the Procrustes distance Pd² between all specimens is calculated:

$${Pd}^{2} = {\sum }_{i = 1}^{n} {\sum }_{j = 1}^{k} {‖ {A}_{i}^{opt} - {R}_{new} ‖}^{2}$$

Next, iterate until convergence is achieved. Scaling, rotating, and updating the reference shape are repeated until the change in Procrustes distance Pd² between iterations is negligible, usually below a set tolerance value (e.g., 1×10⁻⁸).

Next, a principal component analysis is performed. The translated, scaled, and rotated coordinates are orthogonally projected onto the plane tangent to the optimized mean shape. Principal Component Analysis (PCA) is then performed on the aligned shapes to reduce dimensionality and construct a continuous shape space capturing the major variations in the observed shapes:

$$PCA ( {R}_{new} )$$

The non-trivial principal components (PCs explaining individual variance >0) are used in subsequent multivariate statistical analyses, e.g., Procrustes ANOVA, to investigate further and interpret shape differences.

In contrast, the novel GIPPA algorithm proposed here, includes carrying out an Iterative Closest Point algorithm (ICP) within the GPA procedure, to align shapes without landmarks. The ICP algorithm is widely used to align three-dimensional shapes. It iteratively minimizes the difference between two point-clouds by finding the optimal translation and rotation that best aligns them. The algorithm selects the closest points between two sets of 3D data and calculates the transformation that reduces the overall distance between these points. This process is repeated until convergence is achieved, resulting in a precise alignment of the shapes. ICP is particularly effective for aligning shapes with complex surfaces, making it a valuable tool in applications such as 3D modeling, computer vision, and morphometric analysis.

First, the ICP algorithm aligns two point-clouds P and Q, by iteratively minimizing the distance between corresponding points. The procedure can be described as follows.

First, let

$$P = {\{ {pi}_{i} \}}_{i = 1}^{N} and Q = {\{ {q}_{k} \}}_{k = 1}^{M}$$

be two sets of 3D points, where pᵢ and qₖ are the i-th and k-th points in P and Q, respectively. Next, the transformation matrix T is initialized (typically as the identity matrix).

Next, for each point pᵢ in P, find its closest point, qⱼ, among all qₖ in Q, using a k-d tree to retrieve closest nearest neighbors:

$${q}_{j} = \begin{matrix}arg min \\ {q}_{k} ∈ Q\end{matrix} ‖ {p}_{i} - {q}_{k} ‖$$

This forms a set of corresponding point pairs {(pᵢ, qⱼ)}.

Next, the centroids of the matched point sets are computed:

$${c}_{P} = \frac{1}{N} {\sum }_{i = 1}^{N} {p}_{i}$$

$${c}_{Q} = \frac{1}{N} {\sum }_{j = 1}^{N} {q}_{j}$$

Next, the centroid is subtracted from the respective point sets:

$${P}^{′} = \{ {p}_{i}^{′} = {p}_{i} - {c}_{p} \} , {Q}^{′} = \{ {q}_{j}^{′} = {q}_{j} - {c}_{Q} \}$$

Next, the cross-covariance matrix H is computed:

$$H = {\sum }_{i = 1}^{N} {{p}_{i}^{′} ( {q}_{j}^{′} )}^{T}$$

Next, Singular Value Decomposition (SVD) is performed on H:

$$H = F \sum {G}^{T}$$

Next, the rotation matrix ROT is computed:

$$ROT = G {F}^{T}$$

Next, the translation vector is computed:

$$t = {c}_{Q} - {ROTc}_{P}$$

Next, the transformation matrix T is updated:

$$T ⇐ ( \begin{matrix}ROT & t \\ 0 & 1\end{matrix} )$$

Next, the updated transformation matrix is applied to P:

$$P ← ROTP + t$$

Next, the steps of finding closest points, computing centroids, cross-covariance matrix, SYD, rotation, translation, and updating the transformation are repeated until the changes in the transformation matrix T between iterations fall below a specified threshold or the maximum number of iterations is reached.

As discussed above, the present disclosure provides a landmark-free point cloud shape alignment and analysis method embedding the ICP algorithm within the GPA framework. Incorporating the ICP algorithm utilizing KD-Trees within the GPA procedure allows using the well-known Procrustes Distance as the cost-function metric to align the point clouds of 3D BSM shapes optimally. This 3D point cloud registration approach is novel and combines the strengths of both methods to achieve precise and robust alignment of shapes without relying on predefined landmarks.

To achieve this landmark-free point cloud shape alignment and analysis methodology, the following steps are carried out. First, all specimens are aligned to their respective first two major axes using Principal Component Analysis (PCA) to ensure a unique orientation. This step is critical for standardizing the initial positioning of the point clouds, facilitating more accurate subsequent alignment. In contrast to conventional landmark-based approaches, this first step, PCA-based reorientation enables fully automated, consistent alignment of arbitrarily oriented point clouds, ensuring convergence and repeatability in the downstream registration pipeline.

Next, all specimens are mean-centered by translating each point cloud so that their centroid is at the origin. This is achieved by subtracting the centroid of each specimen from its coordinates:

$${A}_{i}^{′} = {A}_{i} - \overline{{A}_{i}}$$

where Aᵢ is the centroid of the i-th specimen.

Next, the centroid size (cs) of each specimen is then calculated, which is the square root of the sum of squared coordinates:

$$c {s}_{i} = \sqrt{{\sum }_{j = 1}^{k} ( {x}_{i j}^{2} + {y}_{i j}^{2} + {z}_{i j}^{2} )}$$

Next, each centered specimen is subsequently scaled relative to its centroid size (to unity):

$${A}_{i}^{″} = \frac{{A}_{i}^{′}}{{cs}_{i}}$$

The first specimen is used as the initial reference shape:

$$R = {A}_{1}^{″}$$

The ICP algorithm is then employed to align the specimens iteratively. For each current specimen

$${A}_{i}^{″} ,$$

the nearest neighbor points between the specimen and the reference shape R are found using a k-d tree for efficient nearest neighbor searches. For each point pᵢ in

$${A}_{i}^{″} ,$$

we search among all qₖ points in R to find its closest point qⱼ:

$${q}_{j} = {}_{{q}_{k} ∈ R}^{arg min} ‖ {p}_{i} - {q}_{k} ‖$$

Each specimen

$${A}_{i}^{″}$$

is optimally rotated to align with the reference shape R. The optimal rotation matrix ROT is computed using Singular Value Decomposition (SVD), as outlined below. First, a cross-covariance matrix is computed:

$$H = {\sum }_{j = 1}^{N} {p}_{j} {q}_{j}^{T}$$

Next, SVD is performed on H:

$$H = F \sum {G}^{T}$$

Next, the rotation matrix is computed:

$$ROT = {GF}^{T}$$

If the determinant of ROT is negative, indicating a reflection rather than a rotation, the last column of Vis negated to ensure a proper rotation:

$$if det ( ROT ) < 0 then G [ : , - 1 ] ← - G [ : , - 1 ]$$

Next, the rotation matrix is recomputed:

$$ROT = {GF}^{T}$$

Next, the recomputed rotation matrix is applied:

$${A}_{i}^{opt} = {A}_{i}^{″} ROT$$

Next, the reference shape is updated. A new reference shape is calculated by averaging the aligned points across all specimens.

$${R}_{new} = \frac{1}{n} {\sum }_{i = 1}^{n} {A}_{i}^{opt}$$

Next, the Procrustes distance Pd² between all specimens and the reference shape is computed based on:

$${Pd}^{2} = {\sum }_{i - 1}^{n} {\sum }_{j = 1}^{k} {‖ {A}_{i}^{opt} - {R}_{new} ‖}^{2}$$

Next, convergence is sought by iteration. Steps involving finding nearest neighbors, computing rotations, and updating the reference shape are repeated until the change in Procrustes distance Pd² between iterations falls below a predetermined threshold (e.g., 1×10⁻⁸).

Once convergence is achieved, the translated, scaled, and rotated coordinates are orthogonally projected onto the plane tangent to the mean shape. Principal Component Analysis (PCA) is then performed on the aligned shapes to reduce dimensionality and capture the major variations in shape:

$$PCA ( {R}_{new} )$$

The non-trivial principal components (PCs) obtained from the PCA are used in subsequent multivariate statistical analyses to investigate and interpret shape differences further.

By integrating PCA for initial orientation, mean-centering, scaling, and iterative ICP alignment with ‘k-d trees,’ this algorithm provides a robust and efficient framework for landmark-free shape analysis. Using k-d trees for nearest neighbor searches during the ICP iterations significantly improves the computational efficiency, particularly for large datasets. This improvement ensures that the algorithm can handle complex, large-scale shape alignment tasks more effectively. The use of ‘Procrustes distance’ for convergence criteria and PCA for dimensionality reduction further enhances the accuracy and interpretability of the results.

To validate and benchmark this landmark-free method for 3D point cloud alignment and analysis, this study created a simulation using a custom R script using functions from the geomorph and Rvcg packages in R. The script incorporates the ICP algorithm via KD-Trees from within the GPA procedure to use Procrustes Distance as the cost function metric to align the 3D BSM point clouds optimally. This approach provides a robust framework for analyzing 3D BSMs without relying on the assumptions underlying homologous landmarks.

The simulation is fundamentally based on the principle of “random in, random out; pattern in, pattern out.” This means the method's performance is evaluated by its ability to detect random noise and actual pattern signals correctly. In this case, “random” and “noise” mean that any observed difference between BSM groups is due to random sampling variations of the same population where the “true” shape difference is zero. The terms “pattern” and “signal” mean that an observed morphological difference between groups of BSM shapes resulted from sampling different populations where the true shape difference is not zero.

Random in, Random out Conversely, when random noise is introduced into the simulation (random in; e.g., variations that do not correspond to any meaningful shape differences), the method should not falsely detect these as signals (random out). This simulation aspect tests the method's sensitivity and specificity, ensuring it does not produce false positives when no actual BSM shape difference exists.

When a clear and consistent signal, or pattern, is introduced into the simulation (pattern in), the method should accurately detect and quantify this pattern (pattern out). The ability to correctly identify and measure BSM shape differences validates the method's effectiveness and robustness in real-world applications where such patterns represent actual BSM morphological variations caused by different agents or processes.

This principle ensures the simulation is a reliable test of the method's ability to differentiate between true patterns (meaningful shape differences) and random noise (non-significant variations). By demonstrating that the method consistently outputs accurate results in response to clear patterns and ignores irrelevant noise, the simulation provides confidence in the method's application to real-world data where distinguishing between meaningful patterns and random variations is crucial.

Historically, V and U-shaped marks have been particularly valuable models in the study of BSMs due to their distinct characteristics resulting from different taphonomic processes. Researchers have significantly contributed to the knowledge of BSMs by emphasizing the attributes of V-shaped marks, typically narrow, deep incisions with internal striations resulting from sharp-force trauma, such as stone tool usage during butchery. In addition, others have described how chopping marks were also V-shaped but shaped broader than cut marks, often showing fragments of bone crushed inward on the mark's floor. Similarly, others have highlighted the compression forces applied during butchery that create these distinctive marks, setting them apart from broader, U-shaped marks caused by trampling or carnivore activity. These U-shaped marks are generally wider, with a flatter base, and occasionally feature internal striations.

Conducting a simulation to evaluate the GIPPA morphological method by modeling 3D V and U shapes seems natural and highly appropriate. Moreover, modeling the transition between V-shaped and U-shaped marks in a controlled manner offers significant advantages. This approach enables researchers to quantify the varying degrees of “V-ness” or “U-ness” of the marks, providing a continuous measurement to understand these modifications' variability better. By meticulously creating this transition, researchers can more precisely differentiate and interpret the origins of bone surface modifications, enhancing the accuracy and reliability of their analyses.

The simulation employs a custom equation, ƒ(x,y), described below, to generate samples of 3D point clouds drawn from identical and different populations. Initially, two variables but, on average, similar sets of 3D V shapes were created, simulating two samples from the same population. This is an example of introducing random noise into the simulation. These shapes are then superimposed using GIPPA The superimposed coordinates are subjected to PCA, and the resulting non-trivial principal components are visualized and input into a Procrustes ANOVA to test the null hypothesis of no difference between the two sets. In this random-in case, one would expect a result of no difference, meaning a failure to reject the null hypothesis. After hypothesis testing, various metrics like Sums of Squares, F-ratio, and p-values were extracted and saved for later investigation. Additionally, the Z-score representing the standardized difference between the two sampled shape groups is computed and saved. This Z-score indicates how many standard deviations the observed group difference is from a mean difference of zero, serving as a measure of effect size.

The next step involves adjusting the equation's transformation parameter, τ (Tau; further detailed below), to incrementally transform the second set of shapes from V to U configurations. This method introduces a signal into the simulation. Procrustes ANOVA is then employed to compare the shapes across these transformations, ranging from minimal change (random in, comparing V shapes against V shapes) to substantial change (pattern in, comparing V shapes against fully U shapes). Additionally, tests are conducted with increasing per-group sample sizes, from 10 to 100 shapes per group. The objective is to evaluate the performance of GIPPA across varying effect sizes (differences between groups) and sample sizes and to determine the threshold at which Procrustes ANOVA can reliably detect the introduced signal.

The simulation begins by defining the number of simulated landmarks for the shapes, set to n_{LMs}=20. The number of landmarks was chosen here for expedience and convenience. This is followed by creating sequences of landmark x-coordinates and y-coordinates, each ranging from −1 to 1, with 20 equally spaced values, to represent the 20 landmarks, e.g.,

$$X = \{ - 1 , - 0.89 , - 0.79 , … , 0.79 , 0.89 , 1 \}$$

$$y = \{ - 1 , - 0.89 , - 0.79 , … , 0.79 , 0.89 , 1 \}$$

These sequences will be used to create a systematic grid in the x and y directions. To create a 1D array that represents the x-coordinates of each point in the grid, the x values are replicated for each y:

$$xv = \{ {x}_{1} , {x}_{1} , … , {x}_{1} , {x}_{2} , {x}_{2} , … , {x}_{2} , … , {x}_{20} , {x}_{20} , … , {x}_{20} \}$$

Similarly, the y values are replicated according to the number of x values, resulting in a 1D array that represents the y-coordinates of each point in the grid:

$$yv = \{ {y}_{1} , {y}_{2} , … , {y}_{20} , {y}_{1} , {y}_{2} , … , {y}_{20} , {y}_{1} , {y}_{2} , … , {y}_{20} \}$$

The Exponential V-shape and U-shape with Sinusoidal Modulation function is a custom-defined mathematical equation designed to generate 3D surfaces with specific characteristics. The primary structure of the surface can be either a V-shaped or U-shaped cut, which is controlled by an exponential decay term. Additionally, the surface includes minor sinusoidal variations along the x- and y-axes to introduce realistic perturbations.

Mathematically, the function ƒ(x,y) is defined as follows:

$$f ( x , y ) = ( size \cdot exp ( - {\vert x \vert}^{τ} ) + 0.1 \cdot sin ( 0.1 π x ) ) + 0.1 \cdot sin ( 0.1 π y )$$

Here, size and τ are parameters that control the overall size and the sharpness of the shape's floor, respectively. The parameter τ determines the rate of exponential decay and, thus, the sharpness of the shape. For V-shaped BSMs, τ always ranges between 1 and 3, producing a sharper V-like profile, while for U-shaped BSMs, τ ranges between 1 and 5, resulting, on average, in a broader, more rounded profile. For the simulation, arrays are initialized to store the V-shapes and U-shapes. For the V-shapes, a sequence of effect sizes, τ, ranging from 1 to 3 is defined:

$$τ = \{ 1 , 1.11 , 1.22 , … , 2.89 , 3 \}$$

while for the U-shapes τ ranges from τ to b+2, resulting in a broader, more rounded profile, on average.

The parameter size scales the overall size of the shape and is randomly selected from a uniform distribution between 10 and 15. This parameter ensures that the generated shapes have variations in their overall dimensions, contributing to a realistic simulation of surface features. The function also incorporates two sinusoidal components to add realistic perturbations to the surface. The first sinusoidal term, 0.1·sin(0.1πx), introduces variations along the x-axis, while the second term, 0.1·sin(0.1πy), does the same along the y-axis. These sinusoidal terms have relatively small amplitudes compared to the exponential term, ensuring that the primary shape structure remains dominant.

A stochastic component is introduced to create different samples from a standard model. The sharpness parameter τ and the size parameter size are randomly selected for each iteration, producing shape variations. For the V-shaped function, the sharpness parameter τ₁ is selected from Uniform (τ,τ+2), and for the U-shaped function, the sharpness parameter τ₂ is selected from Uniform (τ,τ+2). These randomly generated parameters are used to define the functions:

$${Z}_{V} = {f}_{V} ( x , y ) = ( {size}_{1} \cdot exp ( - {\vert x \vert}^{{τ}_{1}} ) + 0.1 \cdot sin ( 0.1 π x ) ) + 0.1 \cdot sin ( 0.1 π y )$$

$${Z}_{U} = {f}_{U} ( x , y ) = ( {size}_{2} \cdot exp ( - {\vert x \vert}^{{τ}_{2}} ) + 0.1 \cdot sin ( 0.1 π x ) ) + 0.1 \cdot sin ( 0.1 π y )$$

The functions are applied to a grid of x and y values, resulting in matrices Z_{V} and Z_{U} for V-shaped and U-shaped surfaces, respectively. The x and y values are replicated for each iteration to match the grid dimensions, creating ID arrays. The resulting z-values are combined with the x and y coordinates into matrices, then stored in 3D arrays for V-shapes and U-shapes.

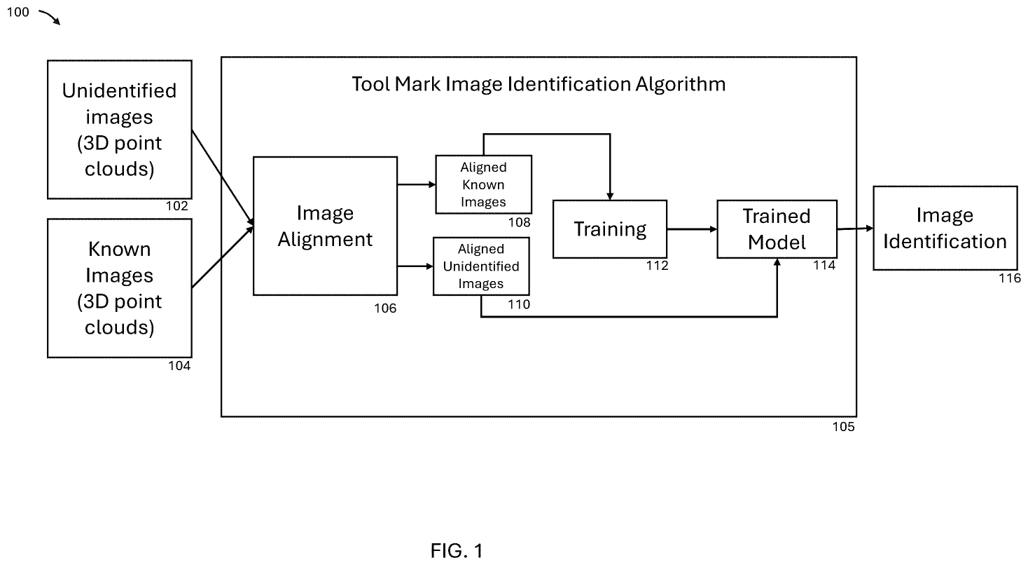

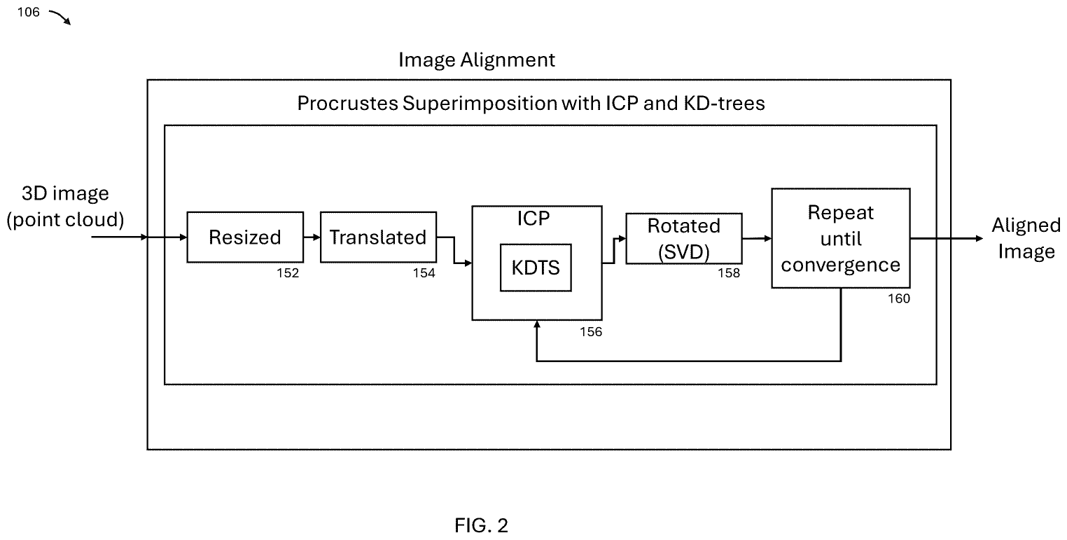

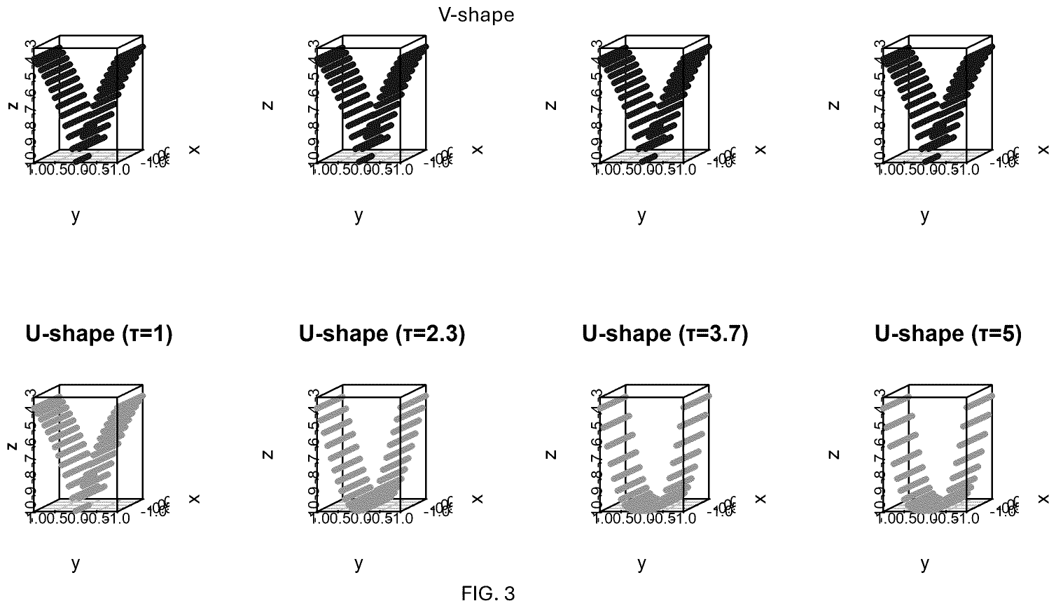

With the theoretical work explained, reference is now made to FIG. 1 which provides a block diagram of the basic flow 100 of the present disclosure. The basic flow 100 begins with a plurality of unidentified images 102 in the form of three-dimensional (3D) point clouds (i.e., each having a plurality of pixels provided in a 3D coordinate system, which describe shape and spatial information of an object in said three-dimensional environment). The unidentified images 102 are of BSM carrying tool marks to be identified. Additionally, known images, again in 3D point clouds, are provided as reference images. The known images 104 may be of V- and U-shaped images to be compared with marks found in the unidentified images 102. These two sets of images (i.e., unidentified images 102 and known images 104) are provided to a processor executing software on a non-transient memory as part of the tool mark image identification algorithm 105. The processor initially aligns these two sets of images in an image alignment block 106, as further described in reference to FIG. 2. The image alignment block 106 outputs aligned known images as shown in aligned known images block 108 as well as aligned unidentified images as shown in aligned unidentified images block 110. The aligned known images are provided from the aligned known images block 108 to a training block 112. The training block 112 can be based on a statistical training process (similar to a curve fit for determining parameters of an equation that best fits a curve using an optimization process, e.g., least means square, as would be known to a person having ordinary skill in the art), or a neural network training process where the aligned known images block 108 provides the aligned known images to a neural network, e.g., a convolutional neural network (CNN) with an input layer, an output layer, and one or more hidden layers with weights therein; wherein the weights are adjusted in a feedback process during the training process by comparing output of the CNN with known outputs (e.g., the original known images, e.g., a U-shaped tool mark with a known transformation parameter τ (see FIG. 3)), and adjusting the weights until the outputs are within a predetermined acceptable threshold of error. In either case, the training block 112 generates a trained model 114, accordingly. That is, in case of a training block 112 that is statistically based, the trained model 114 is a statistical one, however, in case of a training block 112 that is neural network based, the trained model 114 is a neural network. Output of the aligned unidentified images block 110 are then provided to the trained model 114 which outputs an identification of the tool mark in the image identification block 116.

Referring to FIG. 2, the image alignment block 106 is further described. As a general input, a 3D image in the form of a point cloud is shown as input to the image alignment block 106. The steps in the image alignment block 106 are generally known to a person having ordinary skill in the art as the Procrustes Superimposition, however, the steps shown in FIG. 2 differ from the efforts in the prior art. Initially, the input image is resized in the resized block 152 to a predetermined size, so that the unidentified images are of the same size as the known images. The image resizing that occurs in the resized block 152 may include a cropping operation as well as image enlargement or image reduction maintaining the same aspect ratio as the input image or the cropped image using interpolation or extrapolation or other methods, e.g., nearest-neighbor, bilinear, and bicubic interpolation, as known to a person having ordinary skill in the art. The resized image is then provided to a translation block 154. The translation block 154 translates the resized image to a common and predetermined origin using analytical geometry methods, known to a person having ordinary skill in the art. The resized-translated image is then provided to an ICP block 156 wherein the resized-translated image is rotated until it conforms to a predetermined orientation. A KD-tree model adapted to perform landmark-free shape analysis in k-dimensional space is used as part of the ICP block 156. The iterated image being output from the ICP block 156 is provided to a rotation block (rotated (SVD) block 158) which using a an SVD engine performs a matrix factorization that decomposes an input matrix into three other matrices: two orthogonal matrices (G and F) and a diagonal matrix (2) containing singular values as discussed above. The process between the ICP block 156 to rotated (SVD) block 158 is then repeated as indicated by convergence block 160 until convergence is achieved signified by an aligned image that differs from a previous iteration by less than a predefined difference. Output of the convergence block 160 is the output of the image alignment block which is referred to as an aligned image.

Simulations were performed which aimed to investigate the impact of the V-to-U transformation parameter across different sample sizes to ensure sufficient statistical power to detect shape differences. This is achieved using the transformation parameter, τ, which increases with each iteration in small increments, making the U-shapes more distinct from the V-shapes. This transformation is applied within each sample size, starting with a sample of 10 shapes per group and ending with 100 shapes per group.

The V-shaped and U-shaped arrays are combined into a single array, and dimension names are assigned for clarity. The Generalized Iterative Point Procrustes Analysis (GIPPA) is then performed on the combined shapes to output aligned coordinates. These coordinates are subsequently input into a Principal Component Analysis (PCA) to reduce dimensionality and capture significant variations in shape.

The differences between shapes are evaluated by performing Procrustes ANOVA to detect the point at which the ze has enough statistical power to find a signal. This is done by performing GIPPA, PCA, and Procrustes ANOVA at each value of τ within each sample size. This study used the p-value and Z-score of each observed difference as simple yet reliable metrics to quantify and differentiate signal from noise. However, it is good to note that p-values and z-scores depend on sample size and r. In this context, the z-score measures the number of standard deviations that the observed difference between shape groups is from a difference of zero. Consequently, the z-score functions as a good measure of sample effect size.

Results of the simulations are next provided. First, for shape simulation and analysis, the shape simulations according to the present disclosure were conducted to investigate the impact of the V-to-U transformation parameter, τ, across different sample sizes to ensure sufficient statistical power to detect shape differences. By incrementally increasing the range of the transformation parameter, τ, from 1 to 5, the present disclosure generated a range of shapes transitioning from V-like to U-like profiles. This transformation was applied within each sample size, starting with a sample of 10 shapes per group and ending with 100 shapes per group.

The V-shaped and U-shaped groups were combined for analysis. GIPPA was performed on the combined shapes to output aligned coordinates. These coordinates were then inputted into a Principal Component Analysis (PCA) for visualization to reduce dimensionality and capture the major variations in shape, then into a Procrustes ANOVA procedure to test the null hypothesis.

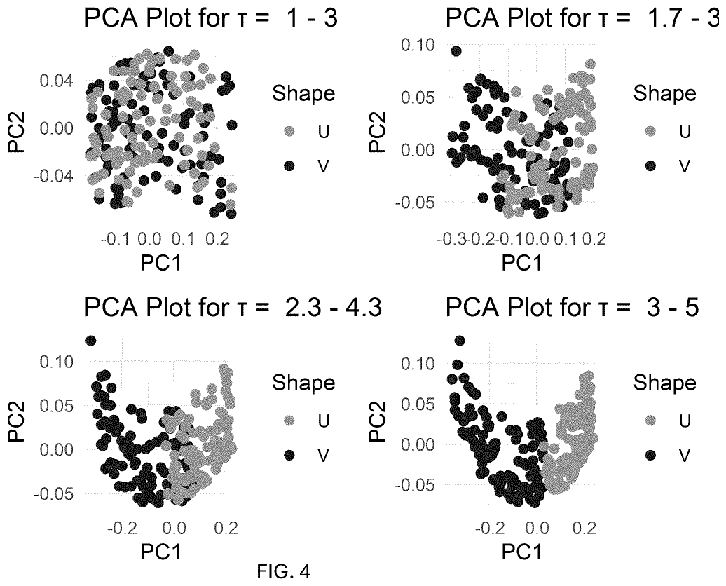

The results of the simulations are visually represented in FIG. 3 (which provides 3D visualizations of simulated V-shapes and U-shapes). Specifically, FIG. 3 illustrates a series of 3D plots. The first row shows V-shapes across four columns, and the second row shows U-shapes across four different values of the transformation parameter τ. In particular, τ values across the columns are: τ=1 in the first column, τ=2.3 in the second column, τ=3.7 in the third column, and τ=5 in the fourth column. Each shape is represented by a point cloud, with V-shapes colored in darker ink and U-shapes in lighter ink. These plots illustrate the gradual transition from V-like to U-like shapes and highlight the increasing distinctiveness of the U-shapes as the effect parameter increases. This visual representation and the PCA plot in FIG. 4 (which provides 2D PCA plots of point clouds for increasing difference between shapes. Each plot displays the point clouds of V-shapes and U-shapes for a specific τ value. The τ values increase from left to right and top to bottom, representing 1.0, 2.3, 3.7, and 5.0, respectively. These PCA plots illustrate the separation between V-shaped and U-shaped point clouds along the first two principal components, highlighting the effect of the transformation parameter on shape differentiation. Each group consists of 50 shapes, providing a clear visual representation of the impact of increasing τ values on shape variation) which clearly illustrate the shape differences detected through the analysis across τ values.

Following GIPPA superimposition, the PCA on the aligned shapes was used to illustrate the spatial overlap between the V-shaped and U-shaped groups. The first two principal components explained a significant proportion of the variance in shape, as illustrated by FIG. 4. As the transformation parameter τ increased, the separation between the clusters became more pronounced, indicating that the transformation parameter successfully produced the desired shape differences.

The simulation analyzed the points at which the effect size and sample size have enough statistical power to detect a signal that the two shape groups were sampled from different populations. This study used p-values and z-scores to do this. In general, such simulations are designed to demonstrate that methods do not produce a false alarm when no signal is present (random out), and to sound an alarm when signal is indeed present (pattern out).

FIG. 5 (which provides visualization of the p-values across different sample sizes and transformation parameter, τ. The colors indicate increasing τ differences, with darker shades representing larger values. The horizontal dashed line represents the traditional statistical significance threshold at (p=0.05) illustrates p-values across different sample sizes and values of the transformation parameter τ, representing the “U-ness” of the shapes. Assuming that, on average, the differences between the means of samples drawn from the same population are 0, the p-value represents the probability of observing a difference as large as or larger than the observed difference purely due to sampling variability. Lower p-values suggest more substantial evidence against the null hypothesis and the assumption that the samples were drawn from the same population.

As sample sizes increase from 10 to 100, p-values generally decrease for all values of τ, demonstrating that larger sample sizes increment the statistical power to detect significant shape differences. Higher values of τ, indicating a more substantial transformation from V to U shapes, are associated with lower p-values across all sample sizes. This relationship is depicted by the progression from lighter to darker shades, with darker shades corresponding to larger τ values. For smaller sample sizes, the difference in p-values between lower and higher τ values is more pronounced, suggesting that with fewer samples, only substantial transformations (higher τ values) are detectable with statistical significance.

The horizontal dashed line at p-value=0.05 represents the conventional threshold for statistical significance. For smaller sample sizes (e.g., n=10 to 20), only higher τ values (e.g., τ ≥2.1) result in p-values below this threshold, indicating that significant shape differences are detectable with a relatively small number of samples only for substantial transformations. As the sample size increases, the range of τ values producing p-values below 0.05 widens. For instance, at a sample size of 100, even lower τ values result in p-values below the 0.05 threshold, demonstrating, as expected, that larger sample sizes improve the ability to detect smaller effect sizes.

For values of τ between 1 and 1.2, where no substantial effect is introduced, p-values remain high across all sample sizes, indicating no significant shape differences are detected. This consistency at higher p-values suggests that when the transformation parameter τ does not introduce a strong effect, the method correctly identifies the lack of meaningful differences, highlighting its robustness in avoiding false positives.

For values of τ between 1.3 and 1.5, the p-values start to decrease as the sample size increases, but they often remain above the conventional threshold of 0.05, especially for smaller sample sizes. This indicates that while some effect may be present, it is not consistently detected as significant unless the sample size is sufficiently large. Researchers should be aware and cautious about sample sizes when dealing with moderate transformation effects (i.e., τ values between 1.3 and 1.5). Insufficient sample sizes may lead to higher p-values, failing to detect potentially meaningful differences. On the other hand, if those differences are due to sampling variability, excessively large sample sizes may lead to false positives. Therefore, ensuring adequate sample sizes tailored specifically to the effect size is critical for reliably identifying different populations in this range of shape differences.

Thus, the pattern of decreasing p-values with increasing sample size is consistent across all values of τ, highlighting the method's robustness in detecting shape differences as the number of samples increases. The convergence of p-values at higher sample sizes (e.g., 80-100) for different τ values suggests that further increases in sample size result in diminishing returns in terms of statistical significance beyond a certain sample size threshold.

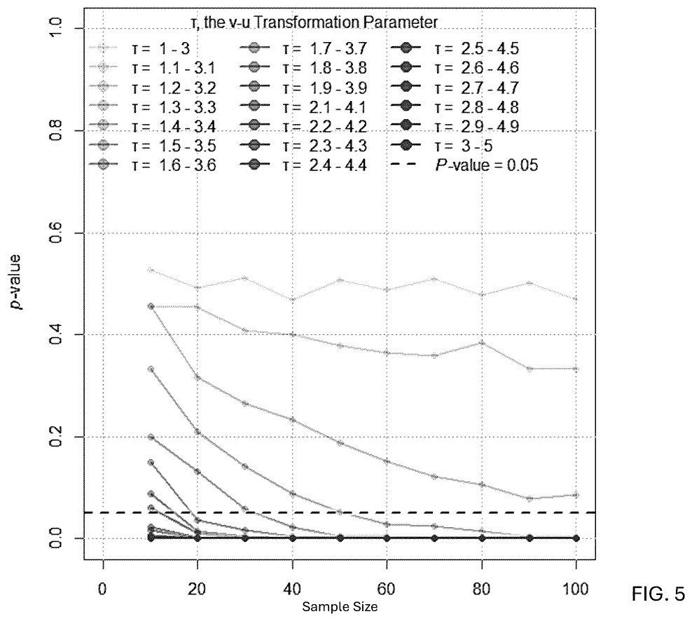

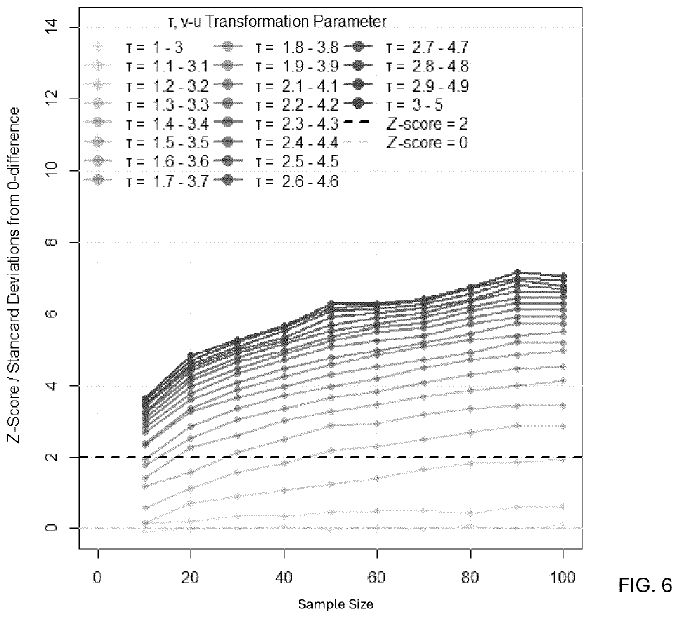

Referring to FIG. 6, Z-scores are provided which quantifies the effect of size across different sample sizes and values of the transformation parameter τ, showing how the observed differences between groups deviate from a mean difference of zero. Z-scores indicate the number of standard deviations by which the observed group difference (i.e., μ₁-μ₂) deviates from zero. Specifically, FIG. 6 provides Visualization of the Z-scores quantifying the number of standard deviations by which the observed difference between groups deviates from a mean difference of zero, effectively serving as an indicator of effect size, across different sample sizes and transformation values of τ. The colors indicate increasing values of$ au$, with darker shades representing larger τ values. The darker horizontal dashed line represents two standard deviations away from 0-difference. The lighter horizontal dashed line represents zero standard deviations away from 0-difference.

As sample sizes increase from 10 to 100, Z-scores also increase consistently for all values of τ, illustrating that larger sample sizes provide greater statistical power to detect shape differences. Higher values of τ, indicating a greater transformation from V to U shapes, generally result in higher Z-scores. This is shown by the progression of Z-scores from lighter to darker red shades, corresponding to increasing τ values. For smaller sample sizes, the differences in Z-scores between lower and higher τ values are more pronounced, suggesting that with fewer samples, only substantial transformations (higher τ values) are detectable.

The horizontal dashed line at Z-score=2 represents the two standard deviations from zero, often used as a benchmark for a meaningful signal of group differences. In this context (the sampling distribution), the interpretation of a Z-score of 2 is that the observed difference between the two sample means is 2 standard deviations above the mean difference, assuming the null hypothesis, μ₁-μ₂=0, is true. A z-score of 2 also corresponds to approximately the 98th percentile in the standard normal distribution. This means that the observed difference between the sample means is greater than −98% of all possible differences that could be expected by sampling from the same population under the null hypothesis. This indicates that if we repeatedly sampled from the population and calculated the difference between sample means, the observed difference would be larger than approximately 98% of those differences. In simpler terms, the observed difference is unusually large, as only 2% of the differences are expected to be more extreme than the observed difference, and the groups likely belong to two different populations. Again, under the null hypothesis.

In this context, for smaller sample sizes (e.g., n=10 to 20), Z-scores for higher τ values (e.g., τ≥2.2) begin to exceed this threshold, indicating that these shape differences are detectable even with a relatively small number of samples. As sample sizes increase, the required τ value for the Z-scores to exceed the threshold decreases. For example, at a sample size of 100, even lower τ values approach or exceed the Z-score threshold, demonstrating the increased power to detect smaller effect sizes with larger sample sizes.

For values of τ between 1 and 1.2, where no substantial effect is introduced, Z-scores remain low across all sample sizes, indicating no substantial shape differences are detected. This consistency at lower Z-scores suggests that when the transformation parameter τ does not introduce a strong effect, the method correctly identifies the lack of significant differences, highlighting its robustness in avoiding false positives.

For values of τ between 1.3 and 1.5, Z-scores rise as the sample size increases but often remain below the threshold of 2, especially for smaller sample sizes. This indicates that while some effect may be present, it is not consistently detected as significant unless the sample size is sufficiently large. Researchers should be cautious about sample sizes when dealing with moderate transformation effects (i.e., τ values between 1.3 and 1.5), as insufficient sample sizes may fail to detect potentially meaningful differences.

However, if the τ values represent differences within a single population that are merely due to sample variability, increasing the sample size can increase the potential of detecting these differences as considerably different, even if they are not meaningful (leading to false positives). Therefore, while larger sample sizes can enhance the detection of true effects, they can also increase the risk of identifying insignificant differences as significant due to heightened sensitivity to slight variations. Researchers should balance the need for sufficient sample sizes with the potential for increased false positives when interpreting results.

Understanding effect sizes can help mitigate this problem by measuring the magnitude of differences, allowing researchers to discern whether detected differences are practically significant and not just statistically significant. Effect size enables contextual interpretation of results, ensuring that even statistically significant findings are evaluated for real-world relevance. Additionally, effect size is essential for power analysis, helping to determine appropriate sample sizes to detect true effects while avoiding excessive sample sizes that could result in false positives. Researchers can achieve more reliable and meaningful conclusions by balancing the need for sufficient sample sizes with the potential for increased false positives and by combining p-values with effect sizes to converge on meaningful conclusions.

The pattern of Z-scores rising with increasing sample size is consistent across all values of τ, underlining the method's robustness in detecting shape differences as the number of samples grows. The convergence of Z-scores at higher sample sizes (e.g., 80-100) for different τ values suggests a diminishing marginal gain in statistical power for detecting shape differences beyond a certain sample size threshold.

These figures illustrate how sample size and the transformation parameter τ influence the statistical power to detect shape differences. Higher values of τ and larger sample sizes lead to lower p-values and higher Z-scores, thereby increasing the likelihood of identifying significant shape differences. This visualization underscores the importance of sufficient sample sizes and substantial transformation parameters in achieving reliable statistical results in shape analysis.

According to the present disclosure, the objective of this simulation was to investigate the method's effectiveness in detecting a signal, represented by p-values and Z-scores (as the a posteriori effect size), across varying values of τ (as the a priori effect size), and sample sizes. Specifically, the goal was to analyze how well the method avoids false positives when no signal is present and accurately identifies a signal as it becomes increasingly stronger using the random in, random out, pattern in, pattern out principle. These simulations ensure the method is robust and reliable, instilling confidence in its application to empirical BSM data.

The results show that the GIPPA method and hypothesis testing pipeline presented here demonstrate strong performance in distinguishing shape differences. The combined use of p-values and Z-scores as performance metrics provides a robust framework for evaluating signal presence and effect sizes. This dual approach highlights the method's robustness, sensitivity, effectiveness in shape analysis, and potential for distinguishing BSMs created by different agents.

BSMs may often be visually identified and differentiated without the need for quantification. Nonetheless, quantifying BSMs to measure their effect sizes is a far superior approach to describing the differences visually. Quantitative measurement offers unparalleled precision and lends itself to employing the language of mathematics, which fosters clear communication among scientists. This common mathematical framework ensures that descriptions and results are universally understood, leading to more nuanced descriptions of BSMs grounded in physics principles, providing a richer comprehension of the natural forces creating the marks.

Effect sizes can objectively measure the difference between groups (among other effects), reducing the influence of subjective interpretation. This ensures that conclusions are based on data rather than personal judgment. Additionally, effect sizes quantify the magnitude and direction of differences, allowing for precise comparisons that visual descriptions often cannot convey, especially from a population perspective. This helps in understanding not just if there is a difference, on average, but how large it is and in which direction it lies.

In BSM research, effect sizes at the population level refer to the expected measurable differences in population parameters (e.g., mean, u and standard deviation, CJ) of BSM shapes caused by various agents, such as human tools, animal interactions, or abiotic natural processes. At the sample level, effect sizes estimate the observed morphological differences between samples, potentially drawn from different populations, for the purpose of hypothesis testing. Measuring BSMs to comprehend their effect sizes is necessary for assessing the impact of different agents on bones, as it indicates the range and extent of BSM morphological variation. This helps researchers determine where the variation of different types of BSM starts and ends in relation to one another.

Quantifying the effect sizes in BSM shapes involves measuring the geometric characteristics of the marks, such as their outline, curvature, orientation, length, width, and depth. Geometric morphometrics achieve this by capturing the spatial coordinates of specific points (landmarks) on the marks' surfaces, from which these geometric characteristics are measured, and analyzing these coordinates to quantify BSM shape variation. Landmark-free geometric morphometrics, such as the Generalized Iterative Point Procrustes Analysis (GIPPA) presented in this study, can accurately measure and analyze BSM shapes without relying on homologous landmarks, which are often absent or difficult to identify in BSMs. Effect sizes are necessary for power analyses, allowing estimation of the sample size needed to detect a practically meaningful difference within a given confidence level. This ensures that studies are adequately powered to find true effects. Quantifying the effect size also enables statistical inference, allowing researchers to test hypotheses and make data-driven conclusions. This moves BSM studies beyond descriptive analysis to inferential statistics, providing stronger evidence for research findings.

The p-value and Z-score figures (FIG. 5 and FIG. 6) together illustrate how sample size and the transformation parameter τ influence the statistical power to detect whether the shape differences are due to sampling two different populations. Higher values of τ and larger sample sizes lead to lower p-values and higher Z-scores, increasing the likelihood of identifying significant shape differences. The Z-score effectively measures effect size by quantifying the number of standard deviations the observed difference deviates from zero. This visualization underscores the importance of sufficient sample sizes and substantial differences to achieve reliable statistical results in BSM shape analysis. By demonstrating the conditions under which a signal is reliably detected, the figures highlight the robustness and sensitivity of the methods used in this study.

p-values are shown for intuitiveness on FIG. 5. These are familiar to researchers who apply frequentist statistics and null hypothesis significance testing. The conventional 0.05 significance level is marked to aid in interpreting the results within this familiar framework. However, relying solely on p-values for making inferences can be problematic due to their sensitivity to sample size, standard errors, and other factors. Therefore, Z-scores depicting effect sizes are also included to provide a more comprehensive perception of shape differences. The Z-scores offer an intuitive measure of effect size, indicating the magnitude of the shape differences in terms of standard deviations, thus complementing the p-value analysis.

Understanding effect sizes through measuring the shape and size of BSMs has several practical implications. Different agents leave distinct patterns and sizes of marks. Establishing the effect sizes of BSMs requires precise quantification to understand the measurable range of shape variability within each BSM population and predict their expected differences and degrees of overlap. For example, stone tools might leave broader, more irregular cuts than metal tools' finer, more precise cuts.

Quantitative measurement, particularly effect sizes, can enhance the scientific rigor of BSM analysis. It provides a standardized approach to reporting findings, reducing subjectivity and increasing the reproducibility of results. This is essential for building a robust and reliable understanding of BSMs. Such measurements mitigate the influence of individual biases or observational errors on findings, thereby providing a less subjective basis for scientific conclusions.

Without quantification, effect sizes cannot be accurately measured or assessed. By quantifying BSMs, researchers gain more precise knowledge of the marks' morphological variability is essential for predicting the shape and size of marks made by various human and other taphonomic factors. Rigorous measurement and comparison of BSMs enhance the ability to construct scientific models that generate empirical predictions, facilitating data-driven reconstructions of past human behaviors. Understanding and measuring relevant effect sizes is important for assessing the impact of different agents on bones, as it indicates the range and extent of BSM morphological variation. This helps researchers determine where the variation of various types of BSM starts and ends in relation to one another.

Those having ordinary skill in the art will recognize that numerous modifications can be made to the specific implementations described above. The implementations should not be limited to the particular limitations described. Other implementations may be possible.

1. A tool mark identification method for analyzing bone surface modifications, comprising:
receiving a plurality of known images with known attributes;
receiving a plurality of unidentified images with unknown attributes including aberrations;
aligning the received plurality of known images to thereby generate a plurality of aligned known images;
aligning the received plurality of unidentified images to thereby generate a plurality of aligned unidentified images;
training a model using the plurality of aligned known images to thereby form a trained model; and
applying the plurality of aligned unidentified images to the trained model, thereby predicting tool marks that generated the aberrations in the unknown attributes.

2. The method of claim 1, wherein the step of training the model is based on a statistical training or based on a neural network training and correspondingly the trained model is a statistical model or a neural network model.

3. The method of claim 2, wherein if the training is based on the neural network model, the neural network is a convolutional neural network.

4. The method of claim 3, wherein the convolutional neural network is a three-dimensional convolutional neural network configured to operate on volumetric or point cloud representations of the surface modifications.

5. The method of claim 1, wherein the model includes a feature extraction module configured to compute local geometric descriptors from each of the plurality of aligned images, and wherein the model outputs a classification label and associated confidence score indicating a predicted tool type.

6. The method of claim 1, wherein each of the plurality of aligned unidentified images are projected into a reduced-dimensional latent shape space prior to application to the trained model, thereby improving model generalization and reducing overfitting.

7. The method of claim 1, further comprising positioning each of the plurality of known images and each of the plurality of unidentified images to its respective first two principal axes using Principal Component Analysis (PCA) prior to the aligning step, thereby standardizing orientation of each of the plurality of aligned known images and each of the aligned unidentified images in a three-dimensional space.

8. The method of claim 1, wherein the steps of aligning the received plurality of unidentified images and aligning the received plurality of known images includes for each said image:
resizing input image thus generating a resized image;
translating the resized image, thus generating a resized-translated image;
applying an Iterative Closest Point (ICP) using a KD tree algorithm to the resized-translated image, thus generating an aligned-translated-resized image based on a known reference; and
rotating the aligned-translated-resized image to this generate an aligned output image.

9. The method of claim 7, wherein the rotation of the aligned-translated-resized image is based on a single value decomposition.

10. The method of claim 1, wherein each of the plurality of known images and each of the plurality of unidentified images is a three-dimensional point cloud image.

11. A system for identifying tool marks when analyzing bone surface modifications, comprising:
an image capture device adapted to capture a red-green-blue image from a scene, wherein the image capture device includes a sensor that captures images upon receiving a digital capture input;
a processor executing software maintained on a non-transitory memory, the processor configured to:
receive a plurality of known images with known attributes;
receive a plurality of unidentified images with unknown attributes including aberrations;
align the received plurality of known images to thereby generate a plurality of aligned known images;
align the received plurality of unidentified images to thereby generate a plurality of aligned unidentified images;
train a model using the aligned known images to thereby form a trained model; and
apply the aligned unidentified images to the trained model, thereby predicting tool marks that generated the aberrations in the unknown attributes.

12. The system of claim 11, wherein the step of train the model is based on a statistical training or based on a neural network training and correspondingly the trained model is a statistical model or a neural network model.

13. The system of claim 12, wherein if the step of train is based on the neural network model, the neural network is a convolutional neural network.

14. The system of claim 11, wherein the convolutional neural network is a three-dimensional convolutional neural network configured to process volumetric or point cloud data representing bone surface modification for predicting tool marks.

15. The system of claim 11, wherein the processor is further configured to extract local geometric features from each of the plurality of known images and each of the plurality of unidentified images and output a classification label and confidence score corresponding to a predicted tool mark.

16. The system of claim 11, wherein the processor projects the aligned unidentified images into a reduced-dimensional latent shape space before applying them to the trained model.

17. The system of claim 11, wherein the steps of align the received plurality of unidentified images and aligning the received plurality of known images includes for each said image:
resize input image thus generating a resized image;
translate the resized image, thus generating a resized-translated image;
apply an Iterative Closest Point (ICP) algorithm to the resized-translated image, thus generating an aligned-translated-resized image, and
rotate the aligned-translated-resized image to this generate an aligned output image.

18. The system of claim 17, wherein the ICP algorithm uses a KD tree.

19. The system of claim 17, wherein the rotation of the aligned-translated-resized image is based on a single value decomposition.

20. The system of claim 11, wherein each of the plurality of known images and each of the plurality of unidentified images is a three-dimensional point cloud image.
